(19) United States
(12) Patent Application Publication
(10) Pub. No.: US 2026/0139486 A1
(43) Pub. Date: May 21, 2026

(54) ADJUSTABLE MAGNET SYSTEM FOR METAL ROOFING PANELS

(71) Applicant: Tanner Tennyson, Poulsbo, WA (US)

(72) Inventor: Tanner Tennyson, Poulsbo, WA (US)

(21) Appl. No.: 18/949,998

(22) Filed: Nov. 16, 2024

(51) Int. Cl. E04D 3/369; E04D 3/16; E04D 13/04; E04D 15/04; H01F 7/02

(52) U.S. Cl. CPC E04D 3/369; E04D 3/16; E04D 15/04; E04D 2013/0454; H01F 7/0252

(57) ABSTRACT

The present invention provides a magnetic device and method for installing metal roofing panels, particularly in valley areas. The device includes a platform with one or more magnets. The installation method involves applying a bonding agent to a valley area, placing the roofing panel, positioning the one or more magnets, adjusting the magnets to match the seam angles, and engaging magnetic force to secure the panel while the bonding agent cures. The device's handle facilitates easy removal after curing, ensuring a durable chemical bond that prevents panel movement from thermal expansion and contraction. This system is compatible with standing seam roofing patterns, including V-ribs, pencil ribs, striated, flat, and bead ribs, enhancing panel alignment, durability, and ease of installation.

### FIELD OF THE INVENTION

The present invention relates to the field of roofing systems, specifically to devices and methods for securing metal roofing panels. More particularly, it pertains to a magnet system designed for the secure attachment of metal roofing panels in valley areas, featuring an adjustable design for customized panel fit, a disconnect lever for ease of removal, and structural enhancements to prevent movement due to thermal expansion and contraction, thereby enhancing panel longevity and maintaining a durable bond against separation forces.

### BACKGROUND

Metal roofing panels are widely used for their durability, aesthetic appeal, and energy efficiency. However, due to exposure to temperature fluctuations, these panels are subject to thermal expansion and contraction, which causes them to move and shift. This movement is particularly problematic at the end of the panels where they can open up, creating gaps and affecting the roofing system's overall integrity. While this issue has been effectively addressed at the eaves through a method where metal panels hem onto or around an eave panel, a similar solution has not been successfully implemented in valley areas of metal roofing systems. In valley areas, where panels lay atop valley metal, the typical solution involves the use of a metal piece called a cleat. This cleat is installed in the valley, and the metal roofing panels are hemmed around it to form a connection. However, this approach incurs significant labor costs, making it impractical for widespread adoption. Consequently, an alternative solution has been the use of metal-compatible caulking to bond the panels to the valley metal or the use of butyl tape which eventually dries out. While this solution addresses the need for cost-effectiveness, it is not ideal for long-term durability and does not provide a secure, mechanically stable connection that can withstand thermal movement over time. Another commonly used alternative for securing metal roofing panels involves driving a hexagonal screw with neoprene washer directly from the top of the panel into the valley metal to create a fixed attachment. However, it leaves an exposed screw head on the surface, which not only detracts from the roof's aesthetic appeal but can also lead to potential water intrusion points as the screw head is exposed to the elements and the neoprene washer can dry out. Additionally, this approach may compromise the roofing panel's durability, as the screw can loosen over time with thermal expansion and contraction. Thus, while functional, the exposed screw method is generally considered undesirable, particularly in applications where aesthetics and long-term weather resistance are critical. In light of the above-mentioned problem statements, there is a need for an improved solution that securely attaches metal roofing panels in valley areas without compromising aesthetics, durability, or installation efficiency.

### BRIEF SUMMARY

The present invention discloses a method and specialized magnet system designed for installing metal roofing panels, specifically on steel standing seam roofs, to create a robust and long-lasting bond in valley areas. The solution addresses the common issue of panel movement caused by thermal expansion and contraction, which often leads to gaps at panel ends. While traditional methods like cleats or metal-compatible caulking exist, they either incur significant labor costs or lack the long term structural stability and waterproofing needed for valley areas. This invention innovatively combines caulking with a temporary clamping mechanism provided by specially designed magnets that can be adjusted to the angle of the panel as it connects to the valley, ensuring a secure bond during the curing process.

In a specific embodiment, a method for installing metal roofing panels to create a secure bond between a roofing panel and a valley metal has been disclosed. The method includes applying a bonding agent to the valley area of the roofing panel. The method further includes positioning the roofing panel over the valley area where the bonding agent has been applied. The method further includes placing one or more magnets over the roofing panel to provide a clamping force sufficient to hold the roofing panel in contact with the valley metal during curing of the bonding agent. The method further includes aligning the one or more magnets with the roofing panel's seams to match the angle of the seams and ensure optimal contact. The method further includes removing the one or more magnets once the bonding agent has cured, thereby completing the installation.

In an embodiment, the one or more magnets comprise one or more permanent magnets made from a material selected from the group consisting of at least neodymium, ferrite, or alnico, providing a strong clamping force. In some embodiments, the method further includes the use of a magnetic device including the one or more magnets and a handle for engaging or disengaging a magnetic force, enabling easy placement and removal of the one or more magnets during the installation process. The one or more magnets are mounted on a platform, providing even pressure distribution across the roofing panel's bonded area to prevent movement during the curing process. The one or more magnets may be positioned to span a bonded area approximately 4 inches in width along the length of the roofing panel, ensuring uniform contact with the valley metal. The one or more magnets may be configured with adjustable end magnets that rotate up to 140 degrees to align with the seam angles of the roofing panel. Further, the one or more magnets are removable after curing without leaving any permanent attachment to the roofing panel, allowing for reuse in subsequent installations.

In some embodiments, the method further includes the step of aligning the one or more magnets by adjusting at least one magnet in multiple directions, including at least rotational and translational movements, to match the seam angles of the roofing panel. In some embodiments, the method further includes selectively engaging and disengaging the one or more magnets by using a push button, allowing precise control over the clamping force applied to the roofing panel. In some embodiments, the one or more magnets are applied in a series of alternating orientations to create a balanced magnetic force distribution across the roofing panel for optimal stability during the curing process.

In another specific embodiment of the present invention, a magnetic device for securing metal roofing panels during installation has been disclosed. The device includes a platform configured to span a bonded area of a metal roofing panel and valley metal. The device further includes one or more magnets mounted on the platform, each magnet configured to generate a clamping force sufficient to hold the roofing panel flat against the valley metal while a bonding agent cures. The one or more magnets may include a first magnet, a second magnet, and a third magnet. The device further includes a handle attached to the platform for engaging and disengaging the clamping force of at least the second magnet by moving between a first position and a second position. The device further includes an adjustment mechanism (such as knobs) for selectively moving the first and third magnets in multiple directions, including back and forth and rotational movement up to 140 degrees around their respective axes, to align with various seam angles of the roofing panel. The magnetic device is configured to be removable after curing of the bonding agent, and wherein the handle enables easy detachment of the device from the roofing panel.

In some embodiments, the handle, when in a vertical position, may disengage the magnetic force of the one or more magnets, and when in a horizontal position, engage the magnetic force of the one or more magnets to secure the roofing panel. In some embodiments, the magnetic device may include a push button that is configured to selectively engage and disengage the one or more magnets, enabling precise control of the clamping force during installation. In some embodiments, the adjustment mechanism may include knobs attached to the one or more magnets, allowing manual rotation and directional movement to align with the roofing panel's seam angles. In some embodiments, the one or more magnets are each positioned within an opening on the platform, enabling movement in a horizontal and vertical direction within the range of the opening for customizable alignment with roofing panel seams.

The present invention offers several key advantages over existing methods for securing metal roofing panels in valley areas. For example, the magnets eliminate the need for labor-intensive cleat installation, providing a cost-effective alternative that maintains structural stability. By ensuring a flat, tight connection with the valley metal, the present invention prevents and reduces the risk of panel shifting, enhancing both the longevity and appearance of the roofing system. The inclusion of adjustable ends and handles simplifies the installation and removal process, saving time and reducing the physical effort required by laborers.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIGS. 1-4 are diagrams that illustrate an exemplary embodiment of using a roofing magnet device.

FIGS. 5-8 are diagrams that illustrate an exemplary roofing magnet device, in accordance with an embodiment of the present invention.

FIGS. 9-11 are diagrams that illustrate movement direction of magnets in the roofing magnet device, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” are used to arbitrarily distinguish between the elements. Thus, these terms are not necessarily intended to indicate temporal or other prioritization of such elements. While various exemplary embodiments of the disclosed invention have been described below it should be understood that they have been presented for purposes of example only, not limitations. It is not exhaustive and does not limit the invention to the precise form disclosed. Modifications and variations are possible considering the above teachings or may be acquired from practicing of the invention, without departing from the breadth or scope.

### Key Definitions:

1. Metal roofing panels: Flat, durable metal sheets used in roofing, known for their weather resistance and longevity. Common materials include steel, aluminum, and copper, with steel panels often being preferred in construction for their strength and cost-effectiveness.
2. Thermal expansion and contraction: The process by which materials, such as metal, expand when heated and contract when cooled. This phenomenon affects roofing panels, causing them to move and sometimes open gaps at the edges or seams.
3. Fish mouth effect: A condition where the ends of metal roofing panels curl or separate due to thermal expansion, creating a gap that resembles a fish's open mouth. This effect compromises the structural and aesthetic integrity of the roof and waterproofing ability/seal.
4. Eave: The lower edge of a roof that overhangs the wall, designed to channel water away from the building. Eave solutions for roofing often involve specific connections, such as hemming, to secure metal panels against movement.
5. Valley (roof valley): An internal angle formed where two sloping roof surfaces meet, directing water flow downwards. Valley areas are particularly susceptible to movement and water intrusion, making secure attachment crucial.
6. Cleat: A metal piece traditionally used to secure roofing panels, typically by hemming (folding) panels around it to keep them in place. Though effective, cleat installation in valleys can be labor-intensive and costly.
7. Metal-compatible caulking: A sealant specifically formulated to create a durable bond with metal surfaces, ensuring a secure and lasting connection. In roofing, caulking is used to bond panels to underlying surfaces like valley metal, helping to prevent leaks and secure the panels.
8. Standing seam roof: A roofing style where metal panels are joined with raised seams that run vertically, creating a sleek, modern look. This design allows for thermal movement while ensuring a weather-tight seal.
9. Magnets: They provide a holding force during the installation process and can be detached after their purpose is fulfilled. In the present invention, removable magnets, such as permanent magnets made from materials like neodymium, may be used to hold panels in place while caulk cures, allowing for easy removal once curing is complete. The invention can utilize permanent magnets, electromagnets, or any combination suitable for providing a strong yet temporary clamping force to maintain panel alignment without creating a permanent attachment to the roofing structure.
10. Clamping force: The force applied by magnets to hold materials together. For this invention, the clamping force of the magnets ensures that the metal roofing panels, and valley metal remain in contact during caulk curing.
11. Curing: The process by which caulk, or adhesive hardens over time, solidifying the bond between materials. Proper curing is essential for caulk to achieve its full sealing and bonding potential.
12. Disconnect lever: A handle or lever on a magnet that facilitates its easy removal. In this invention, the disconnect lever allows workers to quickly release the magnets once the caulk has cured, reducing labor effort.
13. Bonded area: The section where two surfaces are adhered or clamped together. In this invention, the bonded area is approximately 4 inches wide, providing a solid and uniform connection between the panel and valley metal.
14. Roof panel hemming: A technique where the edge of a metal panel is folded over another component, often used to secure metal roofing panels to the structure.

The present invention will now be described with reference to the accompanying drawings which should be regarded as merely illustrative without restricting the scope and ambit of the present disclosure.

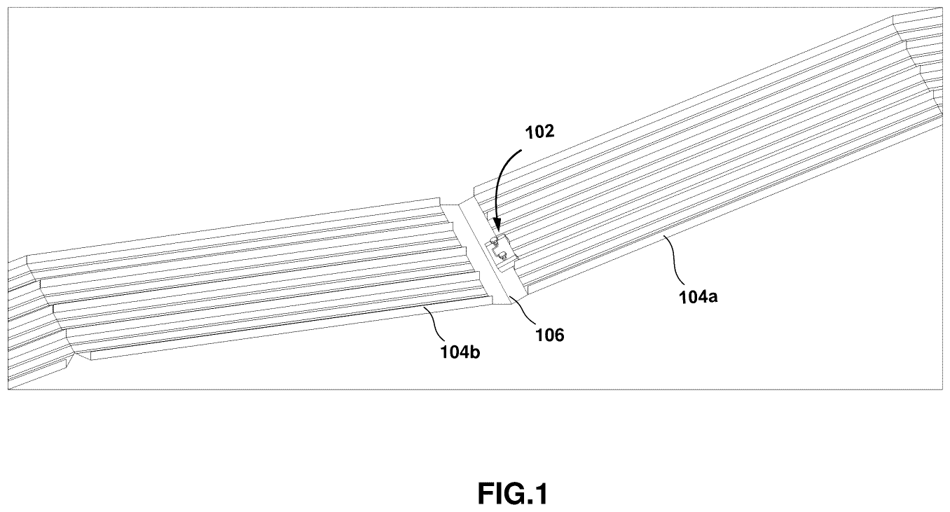

FIGS. 1-4 are diagrams that illustrate an exemplary embodiment of using a roofing magnet device 102. This device 102 has been designed for securing metal roofing panels 104a and 104b, to a roof structure, with a particular focus on a roof valley 106. The valley, an area where two roof slopes meet, often requires additional reinforcement to prevent gaps and ensure the panels 104a and 104b lay flat, especially as they are subject to movement from thermal fluctuations. The magnetic device 102 may include one or more magnets. The magnet types that may be used for the disclosed method may include at least permanent round magnets, rectangular magnets, and magnetic strips, which can all achieve the necessary clamping force for the curing process, depending on the panel's design and requirements. By including options like neodymium or ferrite magnets, the present invention highlights that while a specialized device may be preferred, the method is compatible with various magnet types. This adaptability allows to select a configuration that best fits the panel's shape and size, ensuring optimal performance and ease of use.

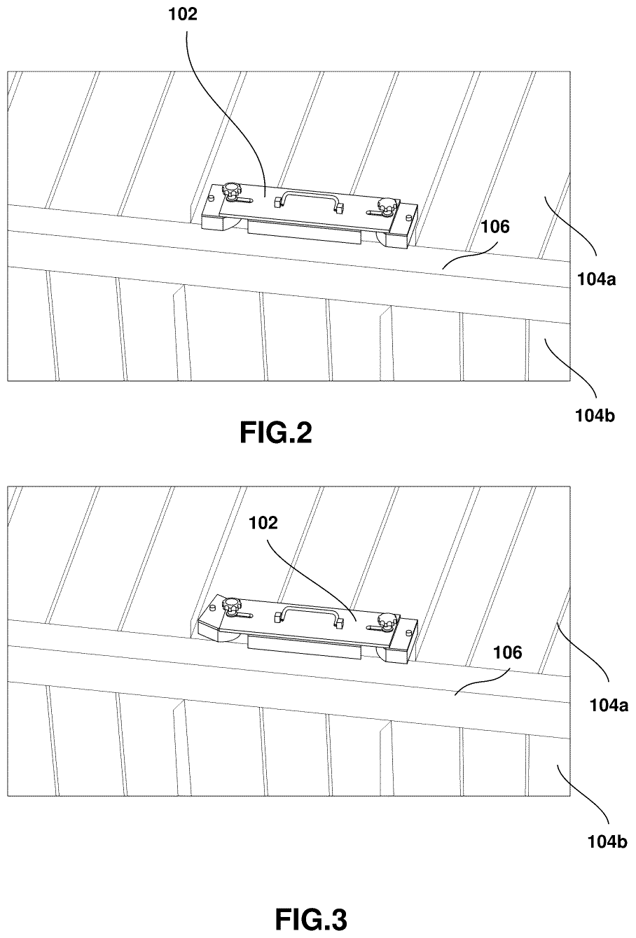

In FIG. 1, the entire installation setup has been presented, showing how the roofing magnet device 102 has been applied across the panels 104a and 104b to create a tight bond with the valley metal 106, ensuring that the caulk applied beneath can cure properly without shifting. FIGS. 2-4 provide close-up views, zooming in on the installation to highlight the specific orientation and positioning of the magnet device's components. In FIG. 3, the focused illustration is on one of the end magnets, which has been rotated. This rotation exemplifies how the magnet ends are adjustable to fit precisely with the angle of the roofing panel seams. By customizing the angle, the device 102 ensures that the magnet sits flush with the panel's cut, creating an even pressure distribution across the panel and maintaining a tight bond with the valley metal 106. In some embodiments, to protect the panel surface and ensure even pressure distribution, optional accessories like spacers or temporary adhesive pads may be used with the one or more magnets. Such accessories help prevent scratching or surface damage from strong magnets, ensuring the panel's aesthetic appeal is preserved. Adhesive pads may temporarily secure the magnets in place for easier alignment before engaging the magnetic force, which can be especially helpful when working with large or uniquely shaped panels.

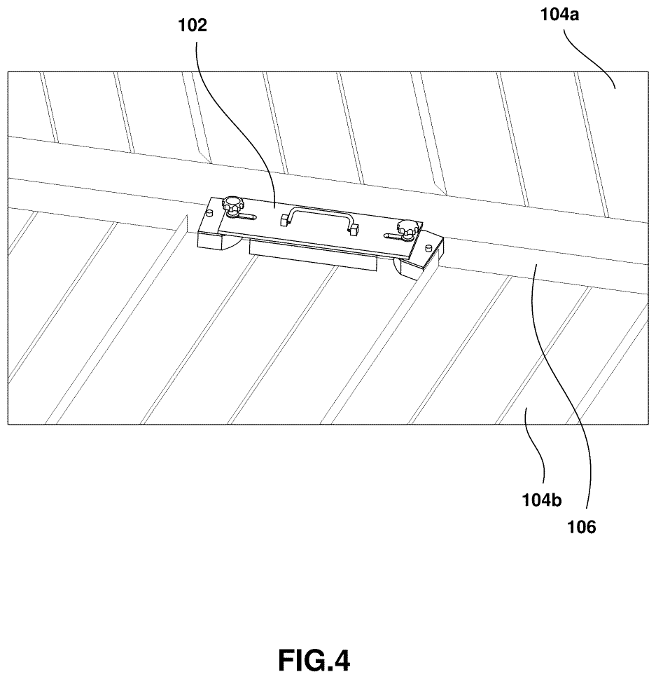

In FIG. 4, the other end magnet has been shown rotated in a similar manner, further illustrating the versatility of the magnet device 102 in adapting to different seam angles on either side of the valley 106. These rotational capabilities of the end magnets provide the flexibility needed to address the varied angles often encountered in roofing panel installations, ensuring a snug, secure fit across the entire bonded area.

Following steps outline the disclosed method for installing the metal roofing panels 104a and 104b using the one or more magnets of the disclosed device 102 to create a secure bond with the valley metal 106. For example, prior to applying the bonding agent, the valley area on the roofing surface and the undersides of the metal roofing panels 104a and 104b may be cleaned and prepared. This step involves removing any dirt, debris, oils, or moisture from the surfaces to optimize bonding. Ensuring that both surfaces are dry and free from contaminants creates ideal conditions for the bonding agent to adhere effectively, thereby promoting a durable chemical bond between the roofing panel 104a or 104b and the valley metal 106. Further, a bonding agent, such as caulk specifically formulated for metal bonding, may be then applied along the valley area. The bonding agent may be applied evenly across the valley metal 106, focusing on areas where the panel 104a or 104b and valley metal 106 will contact. The goal is to create a strong chemical bond that resists separation due to thermal expansion and contraction. With the bonding agent applied, the roofing panel 104a or 104b may be carefully positioned over the valley area, aligning it so that it lies flat against the bonding agent. Proper alignment is crucial at this stage to ensure that the roofing panel 104a or 104b rests evenly, covering the bonding area fully. Further, the device 102, including the one or more magnets mounted on a platform, may be then positioned over the roofing panel 104a or 104b. This device 102 is designed to provide uniform clamping force across the bonded area, ensuring that the roofing panel 104a or 104b maintains consistent contact with the valley metal 106 while the bonding agent cures. The magnets are positioned in such a way that they span the entire bonded area, generally covering a width of approximately 4 inches along the panel's length. This enables secure, temporary clamping pressure that holds the roofing panel 104a or 104b in place, allowing the bonding agent to cure without movement. The device's 102 design ensures that the pressure is evenly distributed, reducing the risk of separation during curing and reinforcing the strength of the final bond. Further, for optimal clamping, the magnets may be aligned with the panel's seams. This step may involve adjusting certain magnets in multiple directions, including rotation, to match the angle of the seams. The adjustment mechanism on the device 102 allows for precise alignment along various seam angles and patterns, such as V-ribs, pencil ribs, or striated patterns, ensuring the magnets lie flush with the panel seams. In some embodiments, the magnetic force may be engaged to hold the roofing panel 104a or 104b firmly against the valley metal 106. In a preferred embodiment, the device 102 includes a handle that enables to switch the magnets between engaged and disengaged states easily. When in the engaged state, the magnets exert sufficient clamping force to keep the roofing panel 104a or 104b immobile throughout the curing process. Engaging the magnets initiates the clamping force necessary to hold the roofing panel 104a or 104b securely while the bonding agent cures. This prevents any movement or misalignment that could compromise the integrity of the bond, ensuring a tight, stable attachment that remains unaffected by external forces during curing. After engaging the magnetic force, the user may monitor the curing of the bonding agent. Curing times may vary depending on environmental conditions such as temperature and humidity. Monitoring the curing process will ensure that the bond reaches its full strength before any adjustments or removal of the magnetic device 102. This step may prevent premature magnet removal, which could lead to bond weakening, providing assurance of a durable and stable connection. Once the bonding agent has sufficiently cured, the one or more magnets may be disengaged incrementally. This sequential removal approach allows the installer to gradually release the clamping force, minimizing stress on the cured bond. In a preferred embodiment, the handle can be returned to a disengaged position, and individual magnets can be released one at a time.

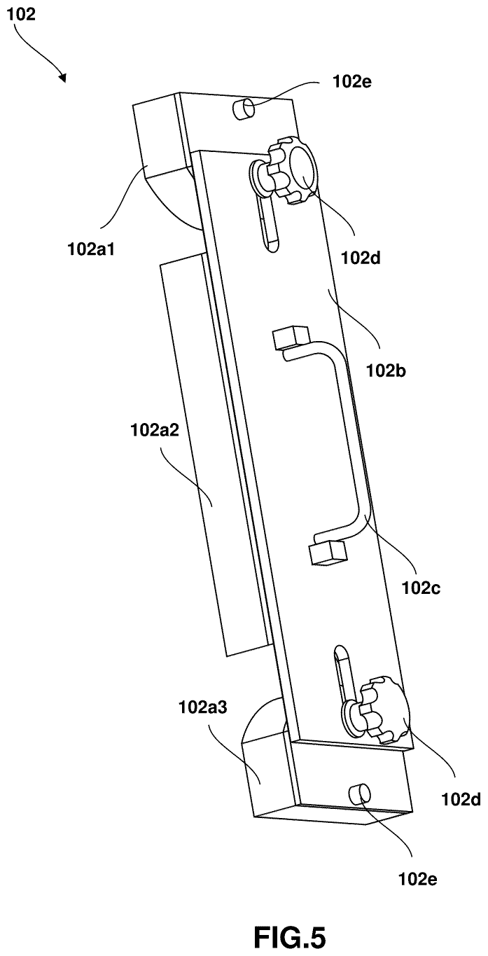

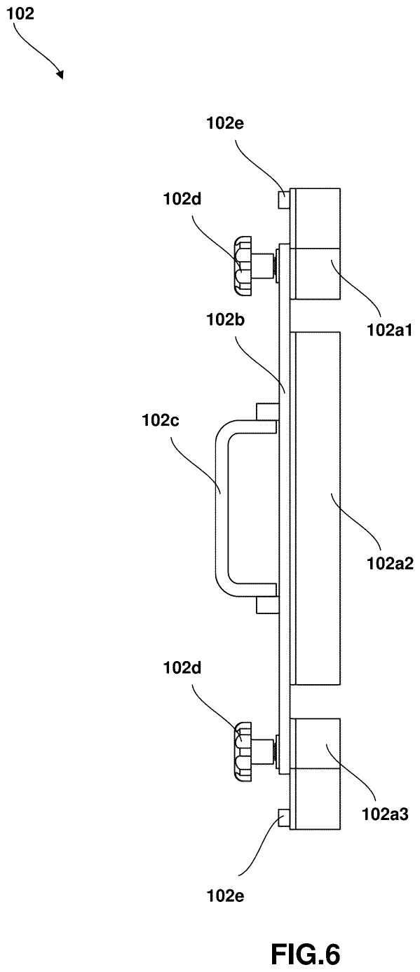

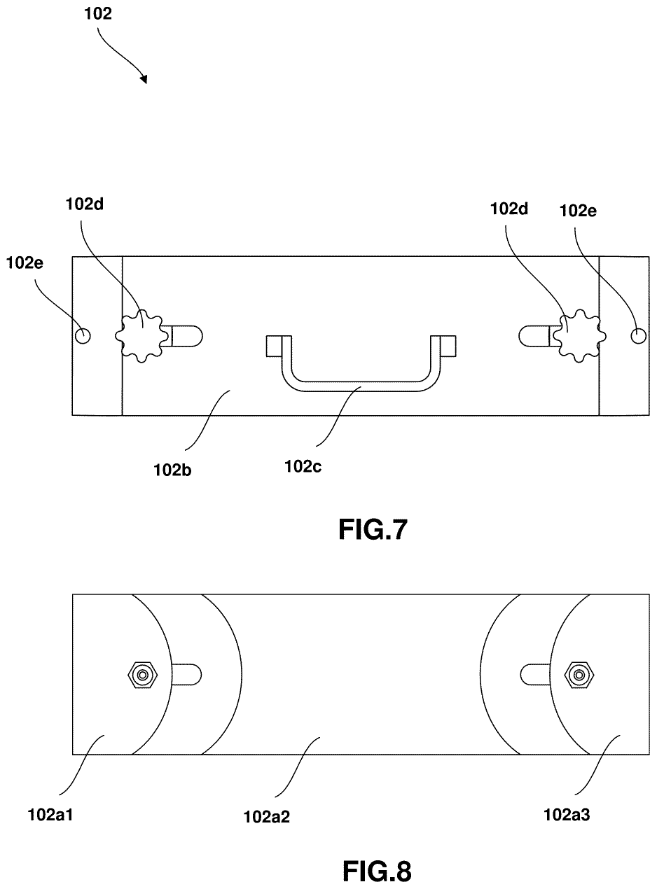

FIGS. 5-8 are diagrams that illustrate an exemplary roofing magnet device 102, in accordance with an embodiment of the present invention. FIGS. 5-8 provide detailed views of the magnetic device 102, showcasing its versatile structure and components. These views, including a side-top perspective (FIG. 5), a side vertical view (FIG. 6), a top view (FIG. 7), and a rear view (FIG. 8), illustrate the design and operational aspects of the magnetic device 102 for securing the metal roofing panels in challenging the valley areas. The magnetic device 102 may be equipped with multiple magnets, such as a first magnet 102a1, a second magnet 102a2, and a third magnet 102a3, each with unique functionalities and movement capabilities for adapting to different roof seam angles and shapes. Central to the device's function is the platform 102b, which acts as a base where the magnets 102a1, 102a2, and 102a3 may be mounted. The platform 102b provides structural support and facilitates the adjustable orientation of the magnets, particularly the magnets 102a1 and 102a3. These magnets 102a1 and 102a3 may be designed with multi-directional movement capabilities, allowing them to shift back and forth, as well as at various angles to the left or right. This adaptability is essential for roofing applications, where the panels may have non-uniform angles or shapes requiring precise alignment. The magnets 102a1 and 102a3 may rotate around their axis within a total range of 140 degrees, enabling fine adjustments to ensure secure attachment along the panel seams, accommodating both horizontal and angled installations.

On top of the platform 102b, the handle 102c may be strategically placed for easy access. The handle 102b also provides an intuitive control mechanism for engaging and disengaging the primary magnet 102a2. For example, in the vertical position, the handle keeps the magnet free, allowing the device 102 to be adjusted or moved without magnetic force. When the handle 102b is laid flat, it engages the magnet 102a2, activating the magnetic hold necessary for securing the roofing panel. This handle 102b functionality allows workers to quickly switch between active and inactive states, minimizing the need for manual force and simplifying the installation process.

Further enhancing the adjustability of the magnetic device 102, the knobs 102d allow the users to manipulate the direction and rotation of the magnets 102a1 and 102a3 around their axis. By adjusting these knobs 102d, the users can fine-tune the alignment of each magnet to match the angle of the roofing panel seam, ensuring an optimal fit along varying seam angle. This flexibility may be essential for achieving a secure bond and preventing gaps or misalignment that could compromise the roof's integrity. Additionally, the push button 102e offers another level of control, allowing the selective engagement and disengagement of the magnets 102a1 and 102a2. When the button 102 e is pressed, the magnets 102a1 and 1023 disengage, enabling repositioning or removal without exerting excess force. This push-button feature provides quick, precise control, ensuring that magnets 102a1 and 1023 are only activated when necessary for the curing process, which is essential for efficient and accurate roof installation.

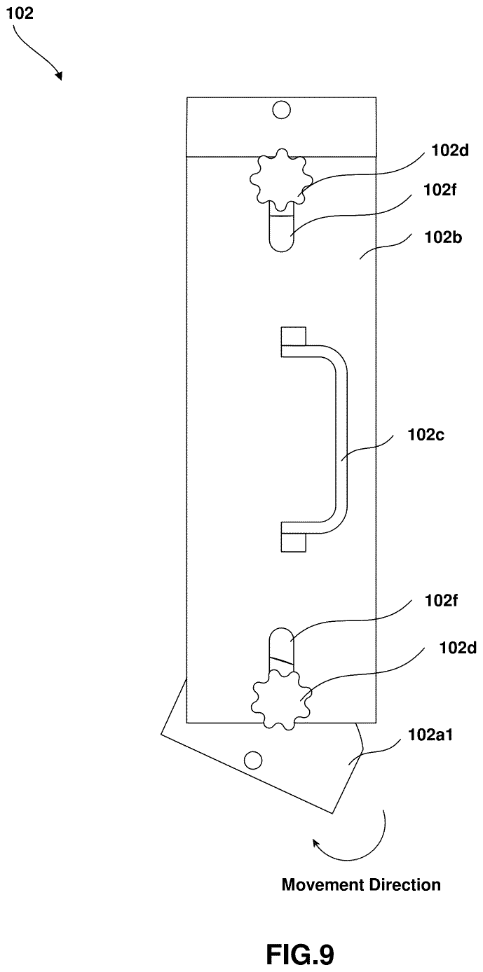

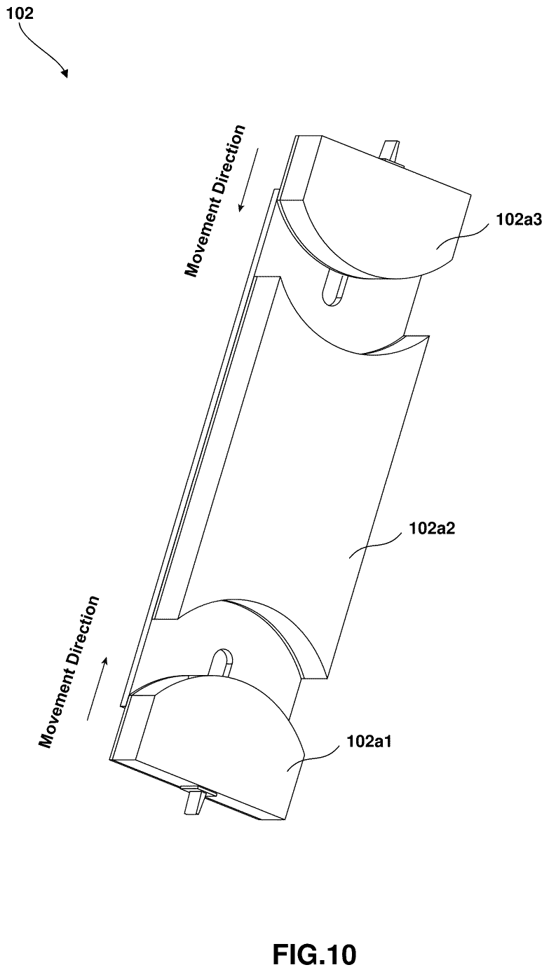

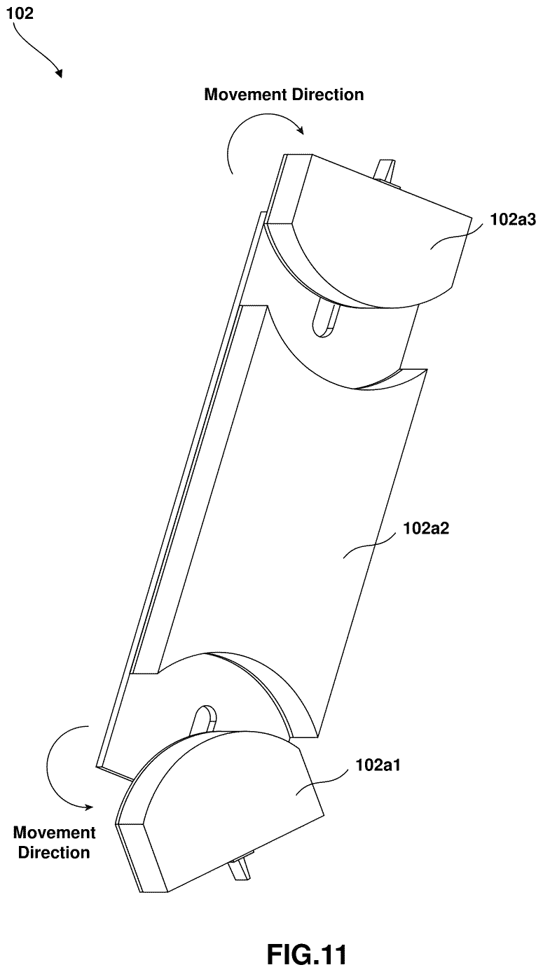

FIGS. 9-11 are diagrams that illustrate movement direction of magnets in the roofing magnet device 102, in accordance with an embodiment of the present invention. In FIGS. 9-11, the movement directions for the magnets 102a1 and 102a3 within the magnet device 102 are illustrated, providing insight into how these magnets 102a1 and 102a3 may be adjusted to align with the roofing panel seams of varying angles and positions. These figures display a set of directional arrows around the magnets 102a1 and 102a3, visually indicating the range and flexibility of movement available. Each magnet, 102a1 and 102a3, may be designed with an adaptable motion capability, allowing it to be precisely positioned relative to the roofing panel and valley area for optimal clamping force and stability during the caulk curing process.

As shown in FIGS. 5-11, the magnet device 102 further includes an opening 102f, at each end, which facilitates the manual or mechanical movement of the magnets 102a1 and 102a3. This opening 102 f allows installers to adjust the magnets 102a1 and 102a3 by either pushing or pulling them in a direction that best aligns with the panel seams. For example, the magnets 102a1 and 102a3 may move both horizontally and vertically within the device's frame, as well as at an angle, enabling precise alignment along the seam. This flexibility is especially useful when the installing metal panels with irregular seam patterns, such as V-ribs, pencil ribs, striated, flat, or bead ribs, each requiring slightly different orientations for a snug fit. The depicted arrows the motion available to each magnet. The magnets 102a1 and 102a3 may shift forward or backward, as well as rotate to an angle, giving them a 140-degree range of rotation around their axis. This level of movement ensures that the magnets 102a1 and 102a3 may be positioned flush against the panel surface, preventing any misalignment that could compromise the curing bond between the roof panel and the valley metal. For example, if the panel cut has a specific angle, the magnets 102a1 and 102a3 may be adjusted to match that exact angle, ensuring a consistent clamping pressure across the bonded area. The openings 102f at each end also enhance the device's usability by providing points where the installers can adjust the magnet positions without fully disengaging them. This approach allows fine-tuning during installation, as the magnets 102a1 and 102a3 may be rotated or repositioned within the opening to adapt to any unique panel characteristics or installation challenges. The versatility of movement around the openings 102f ensures that each magnet 102a1 or 102a3 may adapt to complex roofing profiles, ensuring a secure, tight bond across the roof panel's entire length. This adjustability in the magnetic device 102 highlights its capacity to accommodate the unique needs of metal roofing installations, specifically where secure alignment and durability are critical to preventing panel separation.

The installation and use of the magnet device 102 for securing the metal roofing panels 104a and 104b (FIGS. 1-4) in valley areas is a controlled process that ensures a secure and long-lasting bond. The process begins with preparing the valley area and positioning the metal roofing panels 104a and 104b, ensuring they align correctly. Caulking is then applied between the metal roofing panels 104a and 104b and the valley metal 106. This caulking primarily acts as a bonding agent, forming a chemical bond between the metal surfaces to resist separating forces over time. The primary function of the bonding agent is to create a chemical bond that withstands separation forces over time. This bond may be resilient to external factors such as wind loads, thermal expansion and contraction, and other stresses that can cause panels to shift or separate. While the bonding agent's sealing properties offer added water resistance, the main objective is to achieve a durable, lasting attachment that holds the panels securely to the valley metal, ensuring the integrity of the installation over years, even in varying environmental conditions. The caulking layer provides the primary adhesion, but it requires time to cure, during which the panels 104a and 104b need to be held securely in place to prevent movement due to gravity, thermal expansion, or other external forces. Once the caulking is applied, the magnet device 102 may be placed over the metal roofing panels 104a and 104b, spanning the length of the bonded area. In some embodiments, the magnets may be placed at various points along the panel depending on seam patterns or panel structures. For example, in panels with complex seam arrangements, the one or more magnets may need to be concentrated along specific seams to ensure uniform clamping pressure or placed along the entire length of the bonded area. This flexibility in placement ensures that magnets can maintain a consistent bond across different seam patterns, reducing potential separation points and enhancing long-term stability.

The magnetic device 102 includes multiple magnets (such as 102a1, 102a2, and 102a3) that are sized and positioned to create a strong clamping force along a 4-inch width across the panels 104a and 104b. This clamping force may be essential for keeping the panels 104a and 104b flat and in tight contact with the valley metal 106, ensuring that the caulking cures without any disruptions in the bond. To engage the magnets 102a1, 102a2, and 102a3, the installer uses the handle 102c and the buttons 102e located on the platform 102b of the magnetic device 102. When this handle 102b is in the vertical position, the magnet 102a2 is disengaged, allowing the installer to position the device precisely over the panel without interference from magnetic force. Once aligned, the handle may be lowered into a horizontal or flat position, engaging the magnets and activating the clamping force across the bonded area. This clamping force ensures that the panels 104a. and 104b and the valley metal 106 remain securely bonded throughout the curing process, holding the panel flat and reducing the risk of gaps. To achieve an optimal fit along seams that may not be perfectly flat or straight, the magnets on each end (102a1 and 102a3) are adjustable. Through the openings 102f, the installers can move these magnets back and forth, left and right, or rotate them up to 140 degrees around their axis. This versatility is crucial for the metal roofing panels 104a and 104b with varying seam angles or patterns, such as V-ribs, pencil ribs, striated, flat, or bead ribs. The installer can use the knobs 102d to rotate or adjust the direction of each magnet 102a1 or 102a3, aligning them precisely with the seams to provide consistent pressure and prevent misalignment during curing. The push button 102e provides further control by enabling selective engagement and disengagement of the magnets 102a1 and 102a3. For example, the installer can disengage specific magnets (like 102a1 or 102a2) as needed to reposition the device or adjust alignment without having to lift the entire magnet assembly. Once the caulking has fully cured, which typically occurs over several hours, the installer can remove the magnetic device 102 by pulling the handle 102c back to the vertical position. This releases the magnetic hold, allowing the device to be easily lifted away. The design of the handle 102c simplifies removal, especially with strong magnets, which can otherwise be challenging to detach manually.

The foregoing descriptions of specific embodiments of the present technology have been presented for purposes of illustration and description. They are not intended to be exhaustive or to limit the present technology to the precise forms disclosed, and obviously many modifications and variations are possible considering the above teaching. The embodiments were chosen and described to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology. While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A method for installing metal roofing panels to create a secure bond between a roofing panel and a valley metal, the method comprising:
applying a bonding agent to the valley area of the roofing panel;
positioning the roofing panel over the valley area where the bonding agent has been applied;
placing one or more magnets over the roofing panel to provide a clamping force sufficient to hold the roofing panel in contact with the valley metal during curing of the bonding agent;
aligning the one or more magnets with the roofing panel's seams to match the angle of the seams and ensure optimal contact; and
removing the one or more magnets once the bonding agent has cured, thereby completing the installation.

2. The method of claim 1, wherein the one or more magnets comprise one or more permanent magnets made from a material selected from the group consisting of at least neodymium, ferrite, or alnico, providing a strong clamping force.

3. The method of claim 1, further comprising the use of a magnetic device with a handle for engaging or disengaging a magnetic force, enabling easy placement and removal of the one or more magnets during the installation process.

4. The method of claim 1, wherein the one or more magnets are mounted on a platform, providing even pressure distribution across the roofing panel's bonded area to prevent movement during the curing process.

5. The method of claim 1, further comprising the step of aligning the one or more magnets by adjusting at least one magnet in multiple directions, including at least rotational and translational movements, to match the seam angles of the roofing panel.

6. The method of claim 1, wherein the one or more magnets are positioned to span a bonded area approximately 4 inches in width along the length of the roofing panel, ensuring uniform contact with the valley metal.

7. The method of claim 1, further comprising selectively engaging and disengaging the one or more magnets by using a push button, allowing precise control over the clamping force applied to the roofing panel.

8. The method of claim 1, wherein the one or more magnets are configured with adjustable end magnets that rotate up to 140 degrees to align with the seam angles of the roofing panel.

9. The method of claim 1, wherein the one or more magnets are removable after curing without leaving any permanent attachment to the roofing panel, allowing for reuse in subsequent installations.

10. The method of claim 1, wherein the one or more magnets are applied in a series of alternating orientations to create a balanced magnetic force distribution across the roofing panel for optimal stability during the curing process.
